(19) United States
(12) Patent Application Publication
(10) Pub. No.: US 2014/0286668 A1
(43) Pub. Date: Sep. 25, 2014

(54) ELECTRONIC APPARATUS, CONTROL APPARATUS, CONTROL METHOD, AND NON-TRANSITORY COMPUTER READABLE MEDIUM

(71) Applicant: FUJI XEROX CO., LTD., Tokyo (JP)

(72) Inventor: Hideaki SUGIMOTO, Kanagawa (JP)

(73) Assignee: FUJI XEROX CO., LTD., Tokyo (JP)

(21) Appl. No.: 13/958,713

(22) Filed: Aug. 5, 2013

(30) Foreign Application Priority Data
Mar. 25, 2013 (JP) 2013-062085

(51) Int. Cl. G03G 15/00

(52) U.S. Cl. CPC G03G 15/5016
USPC 399/81

(57) ABSTRACT

An electronic apparatus includes a memory unit that stores procedure information that associates a function with a first procedure in accordance with which the electronic apparatus performs a process corresponding to the function in a standalone fashion, and a second procedure in accordance with which the electronic apparatus performs a process corresponding to the function in cooperation with an external apparatus and a display unit that displays one of an operation screen of the electronic apparatus having at least one operation button and an operation screen of the external apparatus having at least one operation button. The display unit displays the button associated with information related to the first procedure corresponding to the function if the operation screen of the electronic apparatus is displayed, and displays the button associated with information related to the second procedure corresponding to the function if the operation screen of the external apparatus is displayed.

### CROSS-REFERENCE TO RELATED APPLICATIONS

This application is based on and claims priority under 35 USC 119 from Japanese Patent Application No. 2013-062085 filed Mar. 25, 2013.

### BACKGROUND

### Technical Field

The present invention relates to an electronic apparatus, a control apparatus, a control method of the electronic apparatus, and a non-transitory computer readable medium.

### SUMMARY

According to an aspect of the invention, there is provided an electronic apparatus. The electronic apparatus includes a memory unit that stores procedure information that associates a function with a first procedure in accordance with which the electronic apparatus performs a process corresponding to the function in a standalone fashion, and a second procedure in accordance with which the electronic apparatus performs a process corresponding to the function in cooperation with an external apparatus, and a display unit that displays one of an operation screen of the electronic apparatus having at least one operation button and an operation screen of the external apparatus having at least one operation button. The display unit displays the operation button that is associated with information related to the first procedure corresponding to the function if the operation screen of the electronic apparatus is displayed, and displays the operation button that is associated with information related to the second procedure corresponding to the function if the operation screen of the external apparatus is displayed.

### BRIEF DESCRIPTION OF THE DRAWINGS

Exemplary embodiments of the present invention will be described in detail based on the following figures, wherein:

FIG. 1 generally illustrates a configuration of an embodiment of the present invention;

FIG. 2 illustrates a hardware configuration of an image forming apparatus;

FIG. 3 is an external view of an operation unit;

FIG. 4 is a functional block diagram of the image forming apparatus;

FIG. 5 illustrates procedure information;

FIG. 6 illustrates an operation screen;

FIG. 7 illustrates another operation screen;

FIG. 8 illustrates a sequence of a second procedure of facsimile transmission;

FIG. 9 illustrates another operation screen;

FIG. 10 illustrates another operation screen;

FIG. 11 illustrates another operation screen;

FIG. 12 illustrates another operation screen;

FIG. 13 illustrates a sequence of the second procedure of facsimile polling reception;

FIG. 14 illustrates another operation screen;

FIG. 15 illustrates a sequence of the second procedure of accumulation printing; and

FIG. 16 illustrates another operation screen.

### DETAILED DESCRIPTION

### Hardware configuration

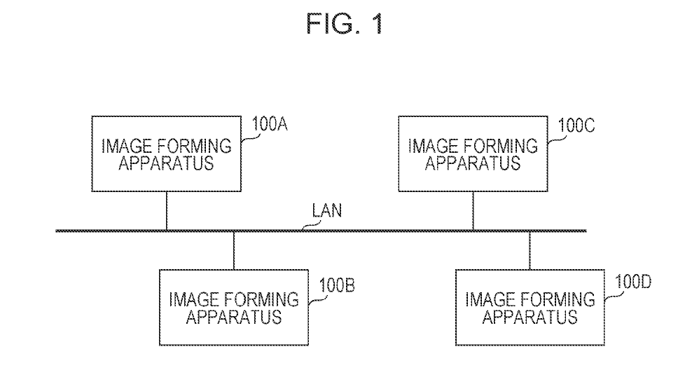

FIG. 1 generally illustrates a configuration of a system of a present embodiment. Image forming apparatuses 100A, 100B, 100C, and 100D are identical to each other in structure, and are interconnected to each via a local area network (LAN). If the image forming apparatuses 100A, 100B, 100C, and 100D are not differentiated from each other in the discussion that follows, they are collectively referred to as an image forming apparatus 100.

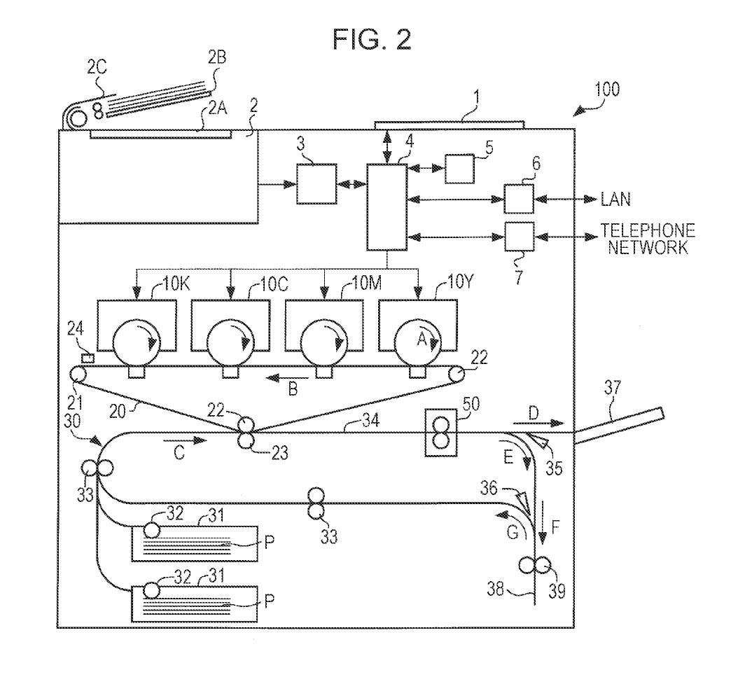

FIG. 2 illustrates a hardware configuration of the image forming apparatus 100. The image forming apparatus 100 is an example of an electronic apparatus as the embodiment of the present invention.

A controller 4 includes a central processing unit (CPU), and memory devices (not illustrated) such as a read-only memory (ROM) and a random-access memory (RAM). The ROM stores firmware that describes a procedure of a startup of hardware and an operating system (OS). The RAM stores data that is used when the CPU performs a computation.

A memory unit 5 is a hard disk device, for example, and stores the OS and application programs. The controller 4 controls each element of the image forming apparatus 100 by performing the OS and the application programs.

A first communication unit 6 is a communication interface (I/F) to be connected to the LAN or other network, and causes the image forming apparatus 100 to interface with another image forming apparatus 100. Communication protocol to be used may be Ethernet (Registered Trademark) or TCP/IP (transmission control protocol/Internet protocol).

A second communication unit 7 is a modem to be connected to a telephone network, and exchanges image data with a facsimile apparatus. Facsimile standard may be International Telecommunication Union Telecommunication Standardization Sector (ITU-T) Recommendation T.30, for example.

A reading unit 2 generates image data by optically reading an original document. More specifically, the reading unit 2 includes a light source, an optical system, an imaging device, and an analog-to-digital converter (all of them are not illustrated). The light source irradiates the original document placed on a platen glass 2A with a light beam, and the optical system separates R (red) color light, G (green) color light, and B (blue) color light from a light beam reflected from the original document. The color light beams are then incident on the imaging device. The imaging device converts the incident light beams into an electrical signal, which is then applied to an image processor 3. The reading unit 2 includes a document tray 2B that holds an original document, and an original document transport mechanism 2C which transports sheets of the original document placed on the document tray 2B to the platen glass 2A one by one.

The image processor 3 performs an image process on image data. More specifically, the image processor 3 analog-to-digital converts the electrical signal supplied from the reading unit 2, performs noise removal, and gamma correction, converts the R color, the G color, and the B color into Y (yellow) color, M (magenta) color, C (cyan) color, and K (black) color, and performs a screen process. The image processor 3 also performs the same processes on image data received by the first communication unit 6 from the outside. Rasterized image data representing color gradation on a per color basis or on a per pixel basis is generated in this way.

In response to the image data supplied from the image processor 3, image forming units 10Y, 10M, 10C, and 10K generate a full-color image by superimposing a Y color toner image, an M color toner image, a C color toner image, and a K color toner image on a surface of a recording medium P, respectively through an electrophotographic system. The image forming units 10Y, 10M, 10C, and 10K are identical in structure to each other. If the image forming units 10Y, 10M, 10C, and 10K are not differentiated from each other in the discussion, they are simply referred to as an image forming unit 10. In such a case, letters Y, M, C, and K are omitted.

A transport unit 30 transports the recording medium P along a transport path 34. More specifically, a medium tray 31 holds sheets of recording media P stacked therewithin. A pickup roller 32 is rotated in synchronization with an operation of the image forming unit 10, transporting the recording media P to the transport path 34 one sheet by one sheet. Transport rollers 33 arranged along the transport path 34 are rotated, thereby transporting the recording medium P along the transport path 34 in a direction labeled an arrow C.

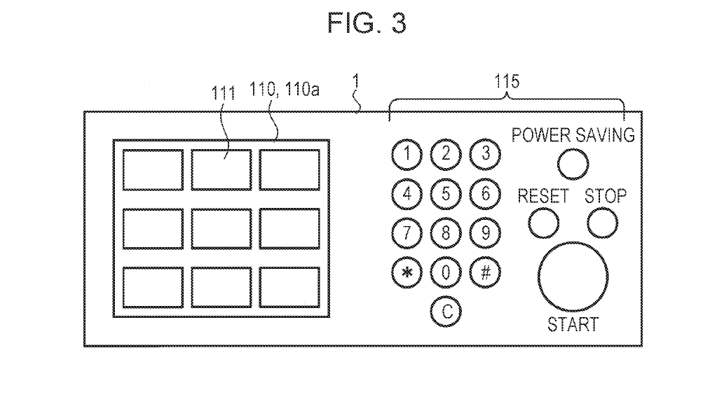

FIG. 3 is an external view of an operation unit 1. The operation unit 1 includes a touch panel 110 and a keypad 115.

The touch panel 110 is a display device including liquid crystal or an electroluminescence (EL) element. The touch panel 110 includes a display region 110a that is rectangular and planer. Operation buttons 111 are displayed on the display region 110a. The operation buttons 111 are virtual operators that are associated with functions of the image forming apparatus 100. The touch panel 110 detects an operation a user has performed on the display region 110a, and in response to the operation, the controller 4 operates the image forming apparatus 100. The touch panel 110 may operate on any mechanism. For example, the touch panel 110 may operate on an electrophotographic capacitance mechanism, an electromagnetic induction mechanism, or any other mechanism.

The keypad 115 includes a group of push-button keys, and includes keys for single digit numbers, and symbols (“*” and “#”), and keys for clear (to cancel an entered numerical value or symbol), reset (to cancel setting), start (to start operation), stop (to stop the operation), and power saving (to switch between power saving states).

### Functional Configuration

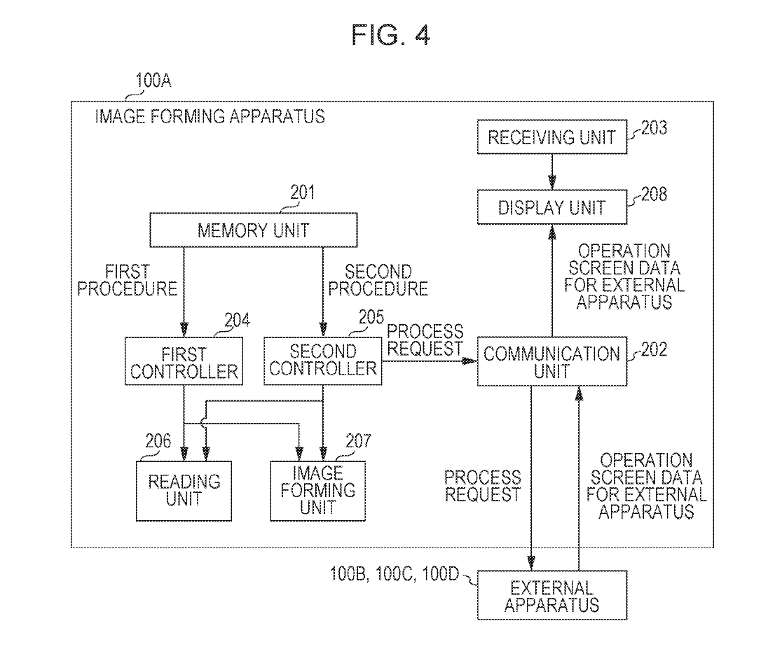

FIG. 4 is a functional block diagram of the image forming apparatus 100. The image forming apparatus 100 includes a memory unit 201, a communication unit 202, a receiving unit 203, a first controller 204, a second controller 205, a reading unit 206, an image forming unit 207, and a display unit 208. These units are implemented when the controller 4 controls hardware of the image forming apparatus 100 in accordance with a program stored on the memory unit 5.

The memory unit 201 is first described. The memory unit 201 stores procedure information 300 that associates a function with a first procedure in accordance with which the apparatus performs a process corresponding to the function in a standalone fashion, and a second procedure in accordance with which the apparatus performs a process corresponding to the function in cooperation with an external apparatus. The operation of the memory unit 201 is described in greater detail as below.

In accordance with the present embodiment, one of a plurality of image forming apparatuses 100 interconnected via a LAN is operated by a user. The user selects between the first procedure in accordance with which the image forming apparatus 100 operated by the user performs the process in a standalone fashion and the second procedure in accordance with which the image forming apparatus 100 performs the process in cooperation with another image forming apparatus 100. In the discussion that follows, the image forming apparatus 100 operated by the user is an apparatus of interest, and an image forming apparatus 100 other than the apparatus of interest (more specifically, a candidate of the image forming apparatus 100 coordinated with the apparatus of interest) is referred to as an external apparatus.

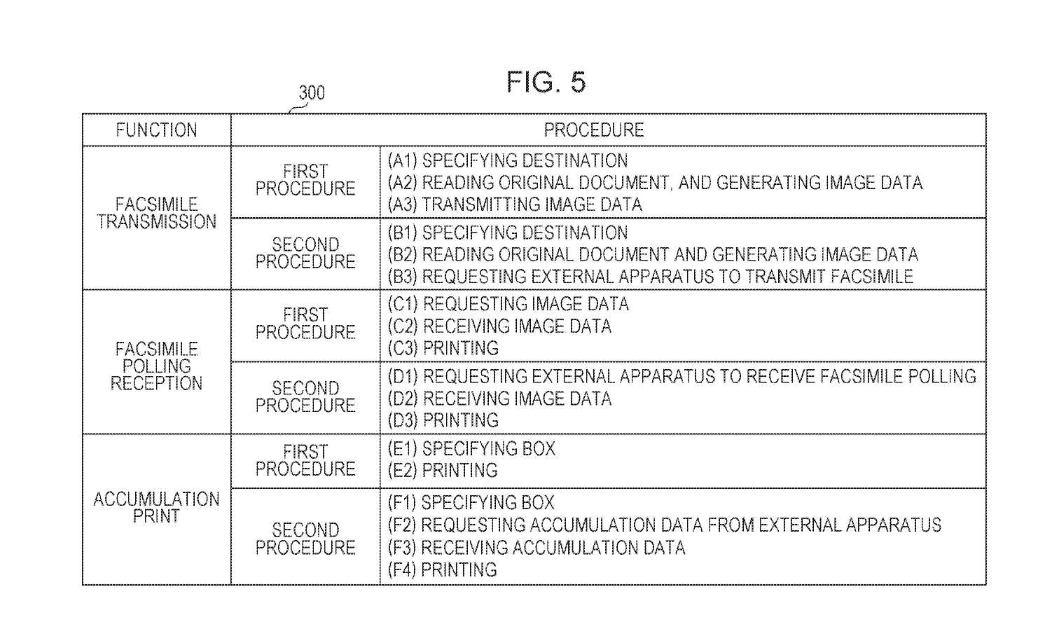

FIG. 5 illustrates the procedure information 300. The procedure information 300 is stored on the memory unit 5.

The “function” in the procedure information 300 is not intended to mean a function of the functional block, but intended to mean facsimile transmission, facsimile polling reception, and accumulation print provided for the user by the image forming apparatus 100. The functions are described in greater detail below.

The procedure of the procedure information 300 includes two procedures, i.e., the first procedure and the second procedure. The first procedure and the second procedure are described below.

### (A) First Procedure of Facsimile Transmission

### (A1) Specifying Destination

The operation unit 1 of the apparatus of interest receives a destination specified by the user.

### (A2) Reading Original Document and Generating Image Data

The reading unit 2 of the apparatus of interest reads the original document and generates image data.

### (A3) Transmitting Image Data

The second communication unit 7 of the apparatus of interest transmits the image data to a facsimile apparatus as the destination via a telephone network.

### (B) Second Procedure of Facsimile Transmission

### (B1) Identical to (A1)

### (B2) Identical to (A2)

### (B3) Requesting External Apparatus to Transmit Facsimile

The controller 4 of the apparatus of interest requests the external apparatus specified by the user to transmit facsimile. The request includes a facsimile number of the destination and the image data generated in step (B2), and is transmitted to the external apparatus via the LAN. Upon receiving the request, the external apparatus transmits the image data to the facsimile apparatus as the destination via the telephone network.

### (C) First Procedure of Facsimile Polling Reception

### (C1) Requesting Image Data

The controller 4 of the apparatus of interest places a call to the facsimile number specified by the user. The facsimile apparatus corresponding to the facsimile number pre-stores the image data for polling reception. The facsimile apparatus transmits the image data to the apparatus of interest via the telephone network.

### (C2) Receiving Image Data

The second communication unit 7 of the apparatus of interest receives the image data.

### (C3) Printing

The image forming unit 10 of the apparatus of interest prints an image responsive to the received image data.

### (D) Second Procedure of Facsimile Polling Reception

### (D1) Requesting External Apparatus to Receive Facsimile Polling

The controller 4 of the apparatus of interest requests the external apparatus specified by the user to receive facsimile polling. The request includes a facsimile number of a transmission source of the image data responsive to polling reception, and is transmitted to the external apparatus via the LAN. Upon receiving the request, the external apparatus places a call to the facsimile apparatus as the transmission source. The facsimile apparatus corresponding to the facsimile number pre-stores the image data responsive to polling reception, and transmits the image data to the external apparatus via the telephone network. The image data is transferred from the external apparatus to the apparatus of interest via the LAN.

### (D2) Receiving Image Data

The first communication unit 6 of the apparatus of interest receives the image data.

### (D3) Printing

The image forming unit 10 of the apparatus of interest prints an image responsive to the received image data.

### (E) First Procedure of Accumulation Print

### (E1) Specifying Box

The operation unit 1 of the apparatus of interest receives a designation of a box specified by the user. The box is a directory of each user generated in the memory unit 5. A box number unique to each directory is assigned to the directory. For example, if a computer connected to the LAN transmits the image data with the box number specified, the image data is stored (accumulated) in association with the box number.

### (E2) Printing

The operation unit 1 of the apparatus of interest receives a print instruction from the user. The image forming unit 10 of the apparatus of interest then reads from the memory unit 5 the image data associated with the box number, and prints an image responsive to the read image data.

### (F) Second Procedure of Accumulation Print

### (F1) Specifying Box

The operation unit 1 of the apparatus of interest receives a designation of a box specified by the user.

### (F2) Requesting External Apparatus to Transmit Accumulation Data

The controller 4 of the apparatus of interest requests the specified external apparatus to transmit the image data associated with the specified box number. The request includes the box number specified by the user, and is transmitted to the external apparatus via the LAN. The image data corresponding to the box number is transmitted from the external apparatus to the apparatus of interest via the LAN.

### (F3) Receiving Accumulation Data

The first communication unit 6 of the apparatus of interest receives the image data.

### (F4) Printing

The image forming unit 10 of the apparatus of interest prints an image responsive to the received image data.

The communication unit 202 is described next. The communication unit 202 interfaces the apparatus of interest with the external apparatus in communications. The communication unit 202 is implemented when the controller 4 controls the first communication unit 6.

The display unit 208 and the receiving unit 203 are described below. The display unit 208 displays an operation screen of the apparatus of interest or an operation screen of the external apparatus, each including at least one operation button. The display unit 208 also displays an operation button associated with information related to the first procedure with respect to the function with the operation screen displayed on the apparatus of interest, and an operation button associated with information related to the second procedure with respect to the function with the operation screen displayed on the external apparatus. The receiving unit 203 receives an operation on the operation screen displayed on the display unit 208. This operation is described in greater detail as below.

The operation screen includes operation buttons for the user to operate the image forming apparatus 100. The memory unit 5 stores operation screen data representing an operation screen. The controller 4 reads the operation screen data from the memory unit 5 and then supplies the read operation screen data to the touch panel 110. The operation screen is thus displayed on the touch panel 110. The operation screen data is layered in structure. The operation screen at one of the layers is displayed in response to an operation performed by the user. The image forming apparatus 100 has a function that allows a facsimile number to be registered, and displays a list of registered facsimile numbers for the user to select a facsimile number. The operation screen data includes data of the list.

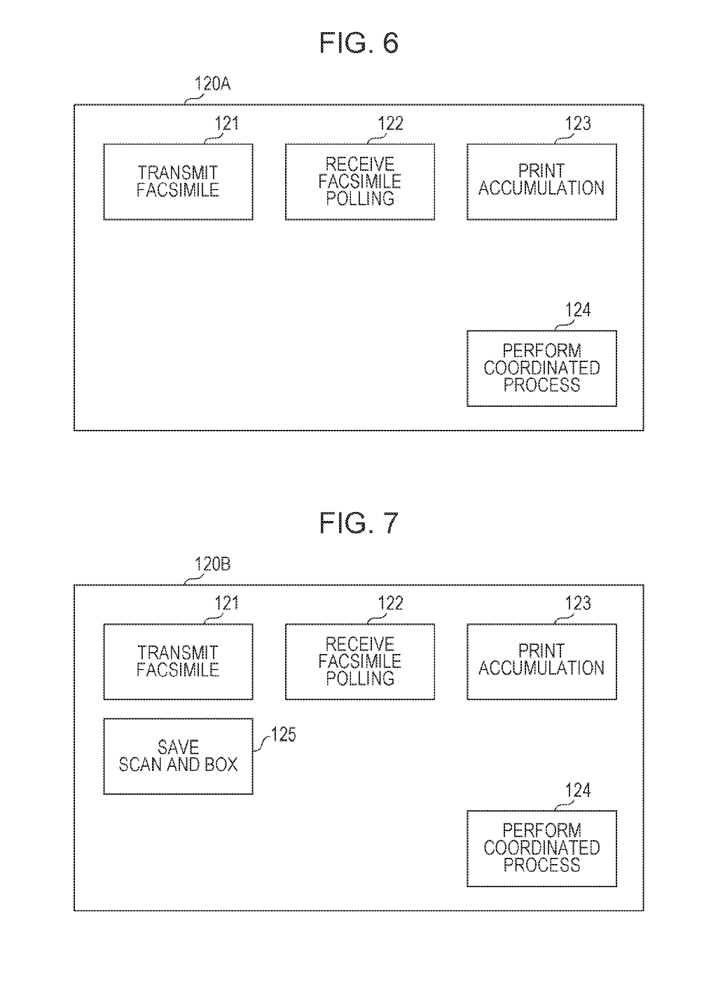

FIG. 6 illustrates an operation screen 120A. The operation screen 120A is displayed first after the image forming apparatus 100 is switched on. Operation buttons 121, 122, 123, and 124 respectively correspond to facsimile transmission, facsimile polling reception, accumulation printing, and coordinated process. When the user touches one of the operation buttons, the operation screen corresponding to the operation button is displayed. The operation screen corresponding to each operation button is described below.

The screen first displayed subsequent to the switch-on of the image forming apparatus 100 is an operation screen of the apparatus of interest. On the other hand, if an operation specifying the external apparatus that is to be coordinated with the apparatus of interest is received (this operation is described in greater detail below), an operation screen of the external apparatus is displayed. An operation button operated by the user in the execution of a process in the first procedure is displayed on the operation screen of the apparatus of interest. An operation button operated by the user in the execution of a process in the second procedure is displayed on the operation screen of the external apparatus.

The first controller 204 is described next. When the receiving unit 203 receives an operation specifying a function, the first controller 204 controls the apparatus of interest so that the process of the apparatus of interest is performed in accordance with the first procedure corresponding to the specified function. More specifically, if the facsimile transmission (operation button 121) is specified on the operation screen 120A, the controller 4 performs the process starting with (A1) in accordance with the first procedure of the facsimile transmission. If the facsimile polling reception (operation button 122) is specified on the operation screen 120A, the controller 4 performs the process starting with (C1) in accordance with the first procedure of the facsimile polling reception. If the accumulation print (operation button 123) is specified on the operation screen 120A, the controller 4 performs the process starting with (E1) in accordance with the first procedure of the accumulation print.

The second controller 205 is described. If the receiving unit 203 receives an operation specifying the external apparatus to be coordinated with the apparatus of interest, if the operation screen displayed on the external apparatus is displayed on the display unit 208, and if the receiving unit 203 receives an operation specifying the function on the displayed operation screen, the second controller 205 controls the apparatus of interest so that a process pre-assigned to the apparatus of interest is performed in accordance with the second procedure associated with the specified function while requesting the external apparatus to perform a process pre-assigned to the external apparatus using the communication unit 202. More specifically, if the coordinated process (operation button 124) is specified on the operation screen 120A, the controller 4 of the apparatus of interest requests the external apparatus specified by the user to transmit the operation screen data representing the operation screen displayed on the external apparatus. The external apparatus then transmits the operation screen data to the apparatus of interest. The controller 4 causes the operation screen responsive to the operation screen data to be displayed on the touch panel 110.

FIG. 7 illustrates an operation screen 120B. The operation screen 120B is an example of the operation screen displayed on the touch panel of the external apparatus specified by the user. The operation screen displayed on the external apparatus may be identical to the operation screen displayed on the apparatus of interest. There are times when the operation screen displayed on the external apparatus is different from the operation screen displayed on the apparatus of interest. For example, the apparatus of interest is different in operation screen from the external apparatus if the user customizes the operation screen on the external apparatus or if the external apparatus has a function different the functions of the apparatus of interest and an operation button corresponding to that function is displayed. FIG. 7 illustrates a case in which an operation button 125 corresponding to save scan and box is added. Save scan and box is a function to store the image data read and generated by the reading unit 2 in the box.

When the facsimile transmission (operation button 121) is specified on the thus-displayed operation screen 120B, the controller 4 performs a process starting with (B1) in accordance with the second procedure of the facsimile transmission. If the facsimile polling reception (operation button 122) is specified on the operation screen 120B, the controller 4 performs a process starting with (D1) in accordance with the second procedure of the facsimile polling reception. If the accumulation print (operation button 123) is specified on the operation screen 120B, the controller 4 performs a process starting with (F1) in accordance with the second procedure of the accumulation print.

### Operation

Operation of the embodiment is described. The operation described below is performed when the controller 4 controls the units in the image forming apparatus 100 in accordance with the program stored on the ROM or the memory unit 5. The operation with the first procedure specified remains unchanged from that in the related art, and the operation with the second procedure specified is described below. A decision as to which image forming apparatus 100 to operate is left to the user. In the discussion that follows, the user operates the image forming apparatus 100A.

### Operation Example 1

### Facsimile Transmission

An operation example 1 is the facsimile transmission that is performed by the apparatus of interest and the external apparatus coordinated with the apparatus of interest.

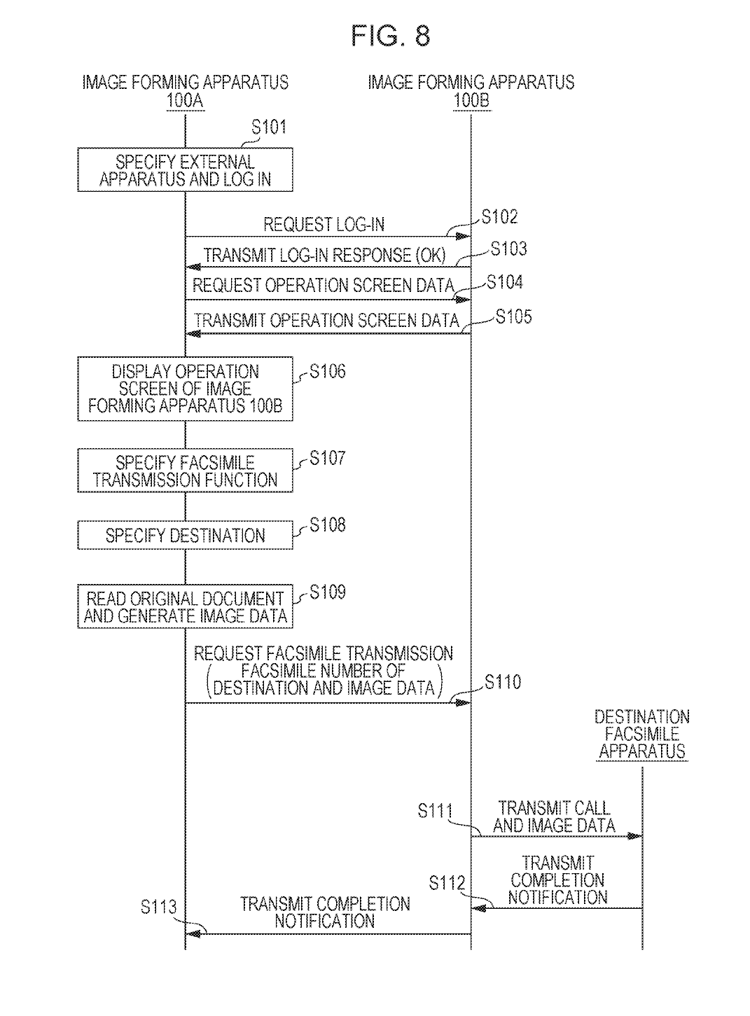

FIG. 8 illustrates a sequence of the second procedure of the facsimile transmission.

The operation screen 120A is displayed on the touch panel 110 of the image forming apparatus 100A (see FIG. 6). The user places an original document on the document tray 2B of the reading unit 2.

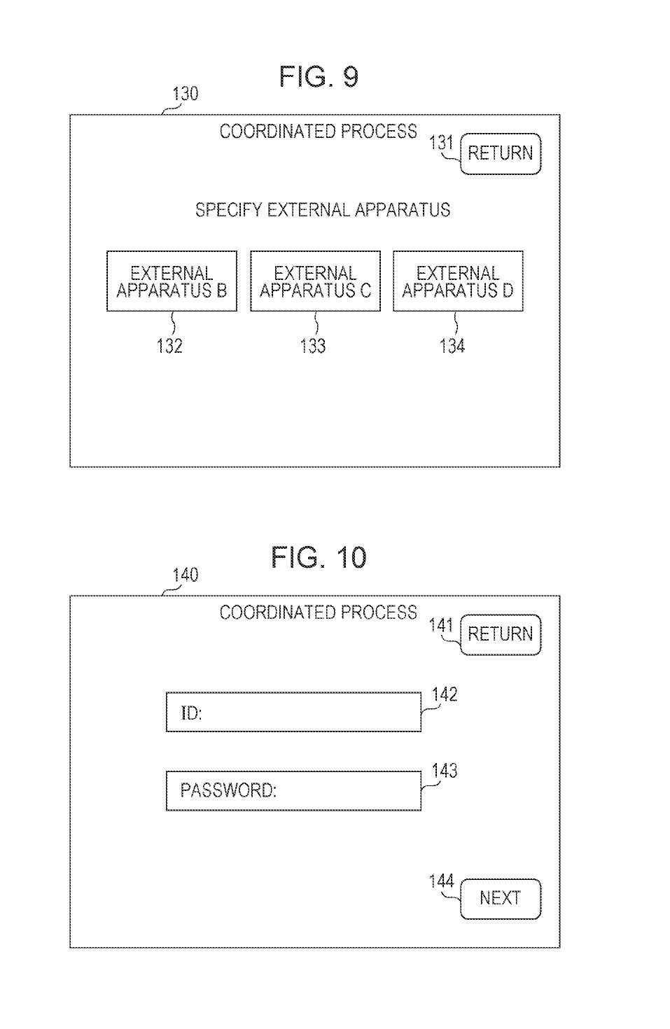

In S101, the user specifies the external apparatus that is to be coordinated with the image forming apparatus 100A, and logs in on the external apparatus. More specifically, when the user specifies “coordinated process” (operation button 124) on the operation screen 120A, an operation screen 130 of FIG. 9 is displayed. If the user touches “Return” (button 131), the operation screen 120A is displayed. “External apparatus B” (operation button 132), “external apparatus C” (operation button 133), and “external apparatus D” (operation button 134) respectively correspond to the image forming apparatuses 100B, 100C, and 100D. The user here specifies the “external apparatus B”.

When the user specifies the “external apparatus B”, the operation screen 140 of FIG. 10 is displayed. Text boxes 142 and 143 are regions where an identifier (ID) and a password are respectively to be entered. The user enters predetermined ID and password using the keypad 115, and touches “next” (operation button 144). Processing proceeds to step S102 (see FIG. 8).

In step S102, the controller 4 of the image forming apparatus 100A transmits the input ID and password to the image forming apparatus 100B, requesting the image forming apparatus 100B to perform a log-in operation. The image forming apparatus 100A communicates with the image forming apparatus 100B via the first communication unit 6 over the LAN.

In step S103, the controller 4 of the image forming apparatus 100B authenticates the ID and password received from the image forming apparatus 100A. If the ID and password are authentic, the controller 4 of the image forming apparatus 100B transmits to the image forming apparatus 100A a response that the log-in operation has been successfully completed.

In step S104, the controller 4 of the image forming apparatus 100A requests the image forming apparatus 100B to transmit the operation screen data.

In step S105, the controller 4 of the image forming apparatus 100B reads the operation screen data from the memory unit 5 and then transmits the read operation screen data to the image forming apparatus 100A.

In step S106, the controller 4 of the image forming apparatus 100A causes the touch panel 110 to display the operation screen responsive to the operation screen data received from the image forming apparatus 100B. The operation screen is the operation screen 120B (see FIG. 7).

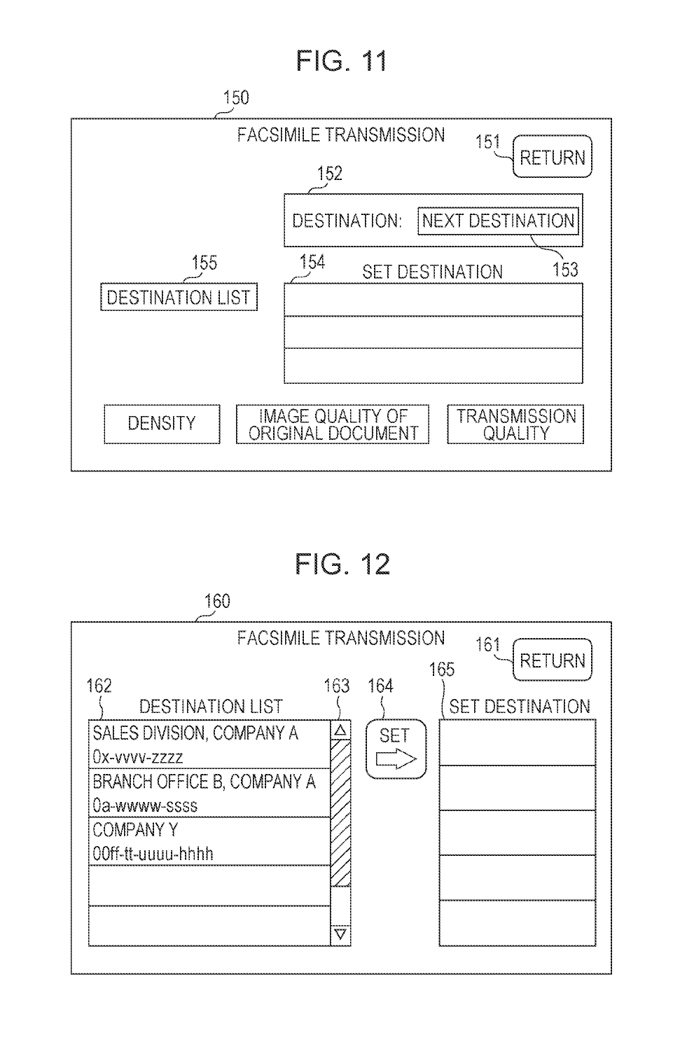

In step S107, the operation unit 1 of the image forming apparatus 100A receives the designation of a function. More specifically, if the user specifies the “facsimile transmission” (operation button 121 of FIG. 7), an operation screen 150 of FIG. 11 is displayed.

In step S108, the operation unit 1 of the image forming apparatus 100A receives the designation of a destination. More specifically, if the user enters the facsimile number of the destination using the keypad 115, the facsimile number is displayed on a text box 152. If the user touches a label “next destination” (button 153), the facsimile number entered in the text box 152 is moved to a text box 154. The addition of the facsimile number is thus received. The destination may be specified using a destination table. If the user touches a label “destination list” (operation button 155), an operation screen 160 of FIG. 12 is displayed. List boxes 162 of the operation screen 160 list the facsimile numbers registered on the image forming apparatus 100B. If the user touches any one of the destinations in the list boxes 162 and a label “set” (operation button 164), a copy of the destination is made in a text box 165.

In step S109, if the user presses on a start key on the keypad 115, the reading unit 2 of the image forming apparatus 100A reads an original document, and generates the image data representing the image of the original document.

In step S110, the controller 4 of the image forming apparatus 100A requests the image forming apparatus 100B to perform the facsimile transmission. The request includes the facsimile number of the destination specified by the user and the image data generated by the reading unit 2.

In step S111, the controller 4 of the image forming apparatus 100B places a call for the facsimile number of the destination received from the image forming apparatus 100A, and then transmits the received image data to the destination. The image forming apparatus 100B communicates with the facsimile apparatus as the destination via the second communication unit 7 over the telephone network.

In step S112, the controller 4 of the image forming apparatus 100B receives from the facsimile apparatus as the destination a completion notification that the reception of the image data has been complete.

In step S113, the controller 4 of the image forming apparatus 100B transmits a completion notification to the image forming apparatus 100A. When the controller 4 of the image forming apparatus 100A receives the completion notification, a character string indicating the completion of the transmission of the image data is displayed on the touch panel 110.

The operation example 1 has been described.

The operation example 1 may be performed in view of the following cases.

In one case, the image forming apparatus 100A may now be installed in a Japanese Office of company X, and the image forming apparatus 100B may be installed in a German Office of company X. Company Y that is in business connection with company X may be located in France. If a facsimile is transmitted from the Japanese Office of company X to company Y, an involved communication fee is lower in the second procedure than in the first procedure.

In another case, the image forming apparatus 100A and the image forming apparatus 100B may be installed in a given branch office of company X, and only the image forming apparatus 100B is connected to the telephone network. In such a case, the second procedure is used to transmit a facsimile because the facsimile transmission is difficult in accordance with the first procedure.

In yet another case, the image forming apparatus 100A may be installed in a meeting room of a given office of company X, and the image forming apparatus 100B may be installed in a living room of a given user. Any participant gains access to the image forming apparatus 100A without going out of the meeting room, for example, to transmit a facsimile during a meeting at the meeting room.

In each of the cases, the facsimile transmission is performed using the operation unit 1 of the image forming apparatus 100A. If the second procedure is selected in the present embodiment, the operation screen displayed on the image forming apparatus 100B is designed to be displayed on the touch panel 110 of the image forming apparatus 100A. The same operability as the operation screen of the image forming apparatus 100B is provided on the image forming apparatus 100A. For example, if a facsimile number of company Y is registered on the image forming apparatus 100B only, the user may log in on the image forming apparatus 100B using the image forming apparatus 100A to acquire the operation screen data of the image forming apparatus 100B. The facsimile number of company Y is thus displayed on the touch panel 110 of the image forming apparatus 100A (see FIG. 12).

### Operation Example 2

### Facsimile Polling Reception

In operation example 2, the facsimile polling reception is performed with the apparatus of interest coordinated with the external apparatus.

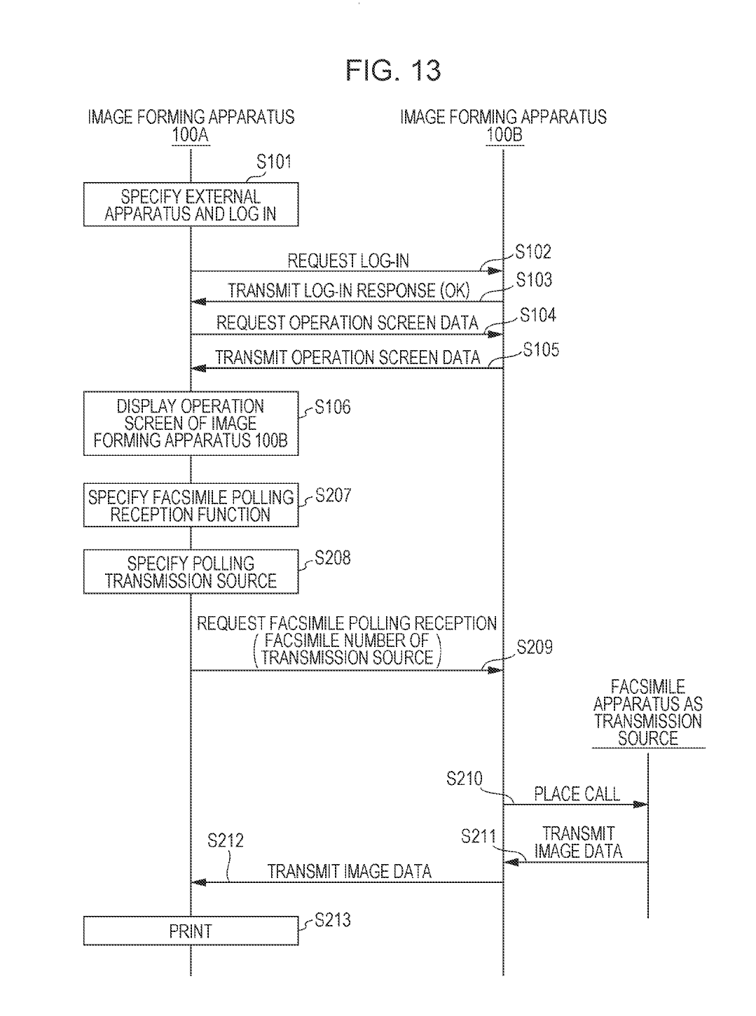

FIG. 13 illustrates a sequence of the second procedure of the facsimile polling reception. In this sequence, the image forming apparatus 100A communicates with the image forming apparatus 100B via the first communication unit 6 over the LAN. The image forming apparatus 100B communicates with the facsimile apparatus as a transmission source of the image data for the polling reception via the second communication unit 7 over the telephone network.

Steps S101 through S106 are identical to those of the operation example 1.

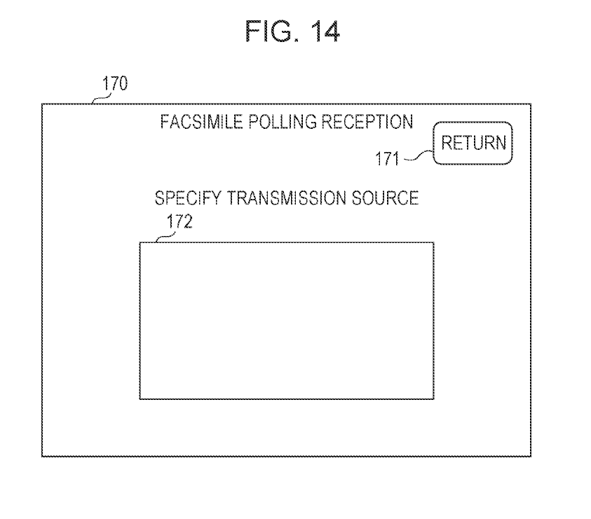

In step S207, the operation unit 1 of the image forming apparatus 100A receives the designation of a function. More specifically, if the user specifies the “facsimile polling reception” (operation button 122 of FIG. 7), an operation screen 170 of FIG. 14 is displayed.

In step S208, the operation unit 1 of the image forming apparatus 100A receives the designation of a transmission source. More specifically, if the user enters the facsimile number of the transmission source of the image data for the polling reception using the keypad 115, the facsimile number is displayed in a text box 172. The transmission source may be specified by specifying the facsimile number from among the pre-registered facsimile numbers in the same manner as in the operation example 1.

If the user presses on the start key on the keypad 115 in step S209, the controller 4 of the image forming apparatus 100A requests the image forming apparatus 100B to perform the facsimile polling reception. The request includes the facsimile number of the transmission source specified by the user.

In step S210, the controller 4 of the image forming apparatus 100B places a call to the facsimile number of the transmission source received from the image forming apparatus 100A.

In step S211, the facsimile apparatus as the transmission source transmits the image data for the polling reception to the image forming apparatus 100B.

In step S212, the controller 4 of the image forming apparatus 100B transmits to the image forming apparatus 100A the image data received from the facsimile apparatus as the transmission source.

In step S213, the image forming unit 10 of the image forming apparatus 100A prints an image responsive to the image data received from the image forming apparatus 100B.

The operation example 2 may be performed on the following cases.

In one case, the image forming apparatus 100A may now be installed in a Japanese Office of company X, and the image forming apparatus 100B may be installed in a German Office of company X. Company Y that is a transmission source of the image data for the polling reception may be located in France. If the Japanese Office of company X receives facsimile polling from company Y, an involved communication fee is lower in the second procedure than in the first procedure.

In another case, the image forming apparatus 100A and the image forming apparatus 100B may be installed in a given branch office of company X, and only the image forming apparatus 100B may be connected to the telephone network. In such a case, the second procedure is used to perform the facsimile polling reception because the facsimile polling reception is difficult to make in accordance with the first procedure.

In yet another case, the image forming apparatus 100A may be installed in a meeting room of a given office of company X, and the image forming apparatus 100B may be installed in a living room of a given user. For example, any participant gains access to the image forming apparatus 100A without going out of the meeting room, for example to perform the facsimile polling reception during a meeting at the meeting room.

In each of the cases, the user gives an instruction of the facsimile polling reception using the operation unit 1 of the image forming apparatus 100A. If the second procedure is selected in the present embodiment, the operation screen displayed on the image forming apparatus 100B is designed to be displayed on the touch panel 110 of the image forming apparatus 100A. The same operability as the operation screen of the image forming apparatus 100B is provided on the image forming apparatus 100A. For example, if a facsimile number of company Y is registered on the image forming apparatus 100B only, the user may log in on the image forming apparatus 100B using the image forming apparatus 100A and may acquire the operation screen data of the image forming apparatus 100B. The facsimile number of company Y is thus displayed on the touch panel 110 of the image forming apparatus 100A (see FIG. 12).

### Operation Example 3

### Accumulation Print

In operation example 3, accumulation print is performed with the apparatus of interest coordinated with the external apparatus.

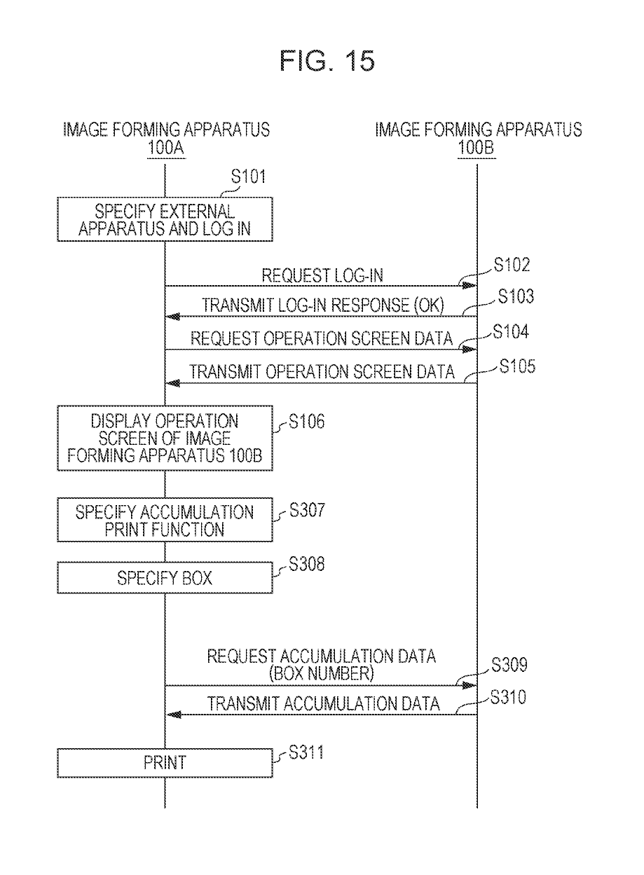

FIG. 15 illustrates a sequence of the second procedure of the accumulation print.

Steps S101 through S106 are identical to those of the operation example 1.

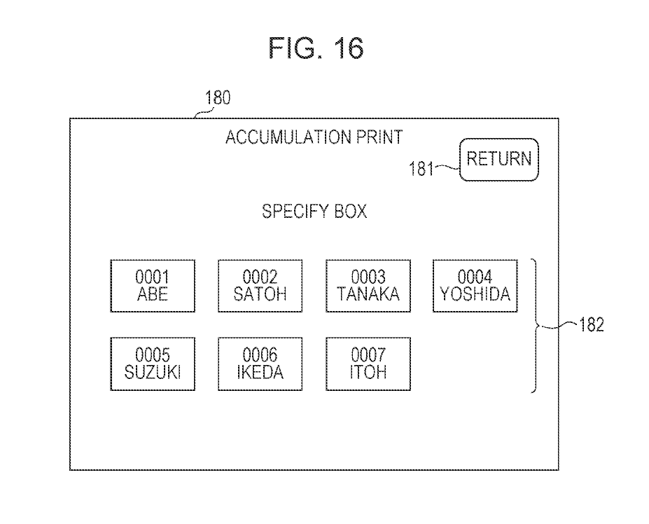

In step S307, the operation unit 1 of the image forming apparatus 100A receives the designation of a function. More specifically, if the user specifies the “accumulation print” (operation button 123 of FIG. 7), an operation screen 180 of FIG. 16 is displayed.

In step S308, the operation unit 1 of the image forming apparatus 100A receives the designation of a box. More specifically, boxes registered on the image forming apparatus 100B are displayed on the operation screen 180, and the user specifies the box corresponding to himself or herself.

In step S309, the user may press on the start key of the keypad 115. The controller 4 of the image forming apparatus 100A requests the image forming apparatus 100B to transmit the image data. The request includes a box number of the box specified by the user.

In step S310, the controller 4 of the image forming apparatus 100B reads from the memory unit 5 the image data associated with the box number received from the image forming apparatus 100A, and then transmits the image data to the image forming apparatus 100A.

In step S311, the image forming unit 10 of the image forming apparatus 100A prints an image responsive to the image data received from the image forming apparatus 100B.

The operation example 3 may be performed on the following cases.

In one case, the image forming apparatus 100A may be installed in a meeting room of a given office of company X, the image forming apparatus 100B may be installed in a living room of a given user, and the box of the user is set in the image forming apparatus 100B. Any participant gains access to the image forming apparatus 100A without going out of the meeting room, for example, to perform accumulation print during a meeting at the meeting room. If the second procedure is selected in the present embodiment, the operation screen displayed on the image forming apparatus 100B is designed to be displayed on the touch panel 110 of the image forming apparatus 100A. The same operability as the operation screen of the image forming apparatus 100B is provided on the image forming apparatus 100A. For example, the user may log in on the image forming apparatus 100B using the image forming apparatus 100A and may acquire the operation screen data of the image forming apparatus 100B. The operation button of the box set in the image forming apparatus 100B is displayed on the touch panel 110 of the image forming apparatus 100A (see FIG. 16).

### MODIFICATIONS

The embodiment may be modified into modifications described below. The embodiment may be combined with modifications. Plural modifications may be combined.

### Modification 1

In the embodiment, the operation screen data is acquired from the external apparatus if the coordinated process with the external apparatus is selected. Alternatively, in modification 1, the operation screen data of the external apparatus is pre-stored on the memory unit 5 of the apparatus of interest so that the operation screen responsive to the operation screen data is displayed. With the modification 1, communications to acquire the operation screen data are eliminated when the user logs in on the external apparatus using the apparatus of interest.

### Modification 2

The hardware configuration of the image forming apparatus 100 of the embodiment has described for exemplary purposes only. The image forming apparatus 100 may be arranged in a hardware configuration different from that of the embodiment. The image forming apparatuses 100A, 100B, 100C, and 100D may be identical to each other in hardware configuration or may be different from each other in hardware configuration. The number of image forming apparatuses 100 connected to the LAN may be any number equal to or above two.

In the embodiment, the electronic apparatus is an electrophotographic image forming apparatus. Alternatively, the electronic apparatus may be any type of apparatus. For example, the electronic apparatus may be an ink-jet image forming apparatus, or an image forming apparatus without scanner function or facsimile function. The electronic apparatus may be an information processing apparatus such as a personal computer.

### Modification 3

In the embodiment, the functional structure of FIG. 3 is built in the image forming apparatus 100. A control apparatus having the functional structure of FIG. 3 may be arranged as an apparatus separate from the image forming apparatus 100, and the control apparatus may control the image forming apparatus 100 via a communication unit. Optionally, the touch panel 110 (display device) may be arranged as a separate unit from the control apparatus, and the touch panel 110 and the control apparatus may be connected via a communication line.

In the embodiment, the image forming apparatus 100 is operated by the controller 4 that executes a program. The program may be supplied in a recorded form on a non-transitory computer readable recording medium, such as an optical recording medium or a semiconductor memory. The program is then read onto the memory unit 5 from the recording medium. The program may be supplied via an electronic communication network. The same function as described with reference to the embodiment may be implemented using hardware.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic apparatus, comprising:
a memory unit that stores procedure information that associates a function with a first procedure in accordance with which the electronic apparatus performs a process corresponding to the function in a standalone fashion, and a second procedure in accordance with which the electronic apparatus performs a process corresponding to the function in cooperation with an external apparatus; and
a display unit that displays one of an operation screen of the electronic apparatus having at least one operation button and an operation screen of the external apparatus having at least one operation button,
wherein the display unit displays the operation button that is associated with information related to the first procedure corresponding to the function if the operation screen of the electronic apparatus is displayed, and displays the operation button that is associated with information related to the second procedure corresponding to the function if the operation screen of the external apparatus is displayed.

2. The electronic apparatus according to claim 1, further comprising:
a communication unit that communicates with the external apparatus;
a receiving unit that receives an operation performed on the operation screen displayed by the display unit;
a first controller that controls the electronic apparatus so that if the receiving unit receives an operation specifying the function, the electronic apparatus executes a process in accordance with the first procedure associated with the specified function; and
a second controller that controls the electronic apparatus so that if the receiving unit receives an operation specifying the external apparatus to be coordinated with the electronic apparatus, if the operation screen displayed on the external apparatus is displayed on the display unit, and if the receiving unit receives an operation specifying the function on the displayed operation screen, the electronic apparatus executes a process pre-assigned to the electronic apparatus in accordance with the second procedure associated with the specified function while requesting the external apparatus to perform a process pre-assigned to the external apparatus using the communication unit.

3. The electronic apparatus according to claim 2, wherein if the receiving unit receives an operation specifying the external apparatus to be coordinated with the electronic apparatus, the second controller acquires, from the external apparatus via the communication unit, operation screen data representing an operation screen displayed on the external apparatus, and causes the display unit to display an operation screen responsive to the acquired operation screen data.

4. The electronic apparatus according to claim 1, further comprising a reading unit that reads image data from an original document, and generates the image data,
wherein if the receiving unit receives an operation specifying a first function, the second controller controls the electronic apparatus so that the reading unit generates the image data and so that the communication unit transmits the image data to the external apparatus, and the second controller requests the external apparatus to perform a process to facsimile-transmit the image data received from the electronic apparatus to a specified destination.

5. The electronic apparatus according to claim 2, further comprising a reading unit that reads image data from an original document, and generates the image data,
wherein if the receiving unit receives an operation specifying a first function, the second controller controls the electronic apparatus so that the reading unit generates the image data and so that the communication unit transmits the image data to the external apparatus, and the second controller requests the external apparatus to perform a process to facsimile-transmit the image data received from the electronic apparatus to a specified destination.

6. The electronic apparatus according to claim 3, further comprising a reading unit that reads image data from an original document, and generates the image data,
wherein if the receiving unit receives an operation specifying a first function, the second controller controls the electronic apparatus so that the reading unit generates the image data and so that the communication unit transmits the image data to the external apparatus, and the second controller requests the external apparatus to perform a process to facsimile-transmit the image data received from the electronic apparatus to a specified destination.

7. The electronic apparatus according to claim 1, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

8. The electronic apparatus according to claim 2, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

9. The electronic apparatus according to claim 3, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

10. The electronic apparatus according to claim 4, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

11. The electronic apparatus according to claim 5, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

12. The electronic apparatus according to claim 6, further comprising an image forming unit that forms an image in accordance with image data,
wherein if the receiving unit receives an operation specifying a second function, the second controller requests the external apparatus to receive image data through polling, and transmit the received image data to the electronic apparatus, and controls the electronic apparatus so that the communication unit receives the image data and so that the image forming unit forms an image responsive to the image data.

13. The electronic apparatus according to claim 1, further comprising an image forming unit that forms an image in accordance with image data,
wherein if the receiving unit receives an operation specifying a third function, the second controller requests the external apparatus to transmit image data accumulated in the external apparatus to the electronic apparatus, and controls the electronic apparatus so that the communication unit receives the image data and so that the image forming unit forms an image responsive to the image data.

14. The electronic apparatus according to claim 2, further comprising an image forming unit that forms an image in accordance with image data,
wherein if the receiving unit receives an operation specifying a third function, the second controller requests the external apparatus to transmit image data accumulated in the external apparatus to the electronic apparatus, and controls the electronic apparatus so that the communication unit receives the image data and so that the image forming unit forms an image responsive to the image data.

15. The electronic apparatus according to claim 3, further comprising an image forming unit that forms an image in accordance with image data,
wherein if the receiving unit receives an operation specifying a third function, the second controller requests the external apparatus to transmit image data accumulated in the external apparatus to the electronic apparatus, and controls the electronic apparatus so that the communication unit receives the image data and so that the image forming unit forms an image responsive to the image data.

16. The electronic apparatus according to claim 4, further comprising an image forming unit that forms an image in accordance with image data,
wherein if the receiving unit receives an operation specifying a third function, the second controller requests the external apparatus to transmit image data accumulated in the external apparatus to the electronic apparatus, and controls the electronic apparatus so that the communication unit receives the image data and so that the image forming unit forms an image responsive to the image data.

17. The electronic apparatus according to claim 5, further comprising an image forming unit that forms an image in accordance with image data,
wherein if the receiving unit receives an operation specifying a third function, the second controller requests the external apparatus to transmit image data accumulated in the external apparatus to the electronic apparatus, and controls the electronic apparatus so that the communication unit receives the image data and so that the image forming unit forms an image responsive to the image data.

18. A control apparatus, comprising:
a memory unit that stores procedure information that associates a function with a first procedure in accordance with which an electronic apparatus controlled by the control apparatus performs a process corresponding to the function in a standalone fashion, and a second procedure in accordance with which the electronic apparatus performs a process corresponding to the function in cooperation with an external apparatus; and
a display unit that displays, a display device, one of an operation screen of the electronic apparatus having at least one operation button and an operation screen of the external apparatus having at least one operation button,
wherein the display unit displays the operation button that is associated with information related to the first procedure corresponding to the function if the operation screen of the electronic apparatus is displayed, and displays the operation button that is associated with information related to the second procedure corresponding to the function if the operation screen of the external apparatus is displayed.

19. A control method of an electronic apparatus, comprising:
storing procedure information that associates a function with a first procedure in accordance with which the electronic apparatus performs a process corresponding to the function in a standalone fashion, and a second procedure in accordance with which the electronic apparatus performs a process corresponding to the function in cooperation with an external apparatus; and
displaying one of an operation screen of the electronic apparatus having at least one operation button and an operation screen of the external apparatus having at least one operation button,
wherein the displaying includes displaying the operation button that is associated with information related to the first procedure corresponding to the function if the operation screen of the electronic apparatus is displayed, and displaying the operation button that is associated with information related to the second procedure corresponding to the function if the operation screen of the external apparatus is displayed.

20. A non-transitory computer readable medium storing a program causing a computer to execute a process for forming an image, the process comprising:
storing procedure information that associates a function with a first procedure in accordance with which the electronic apparatus performs a process corresponding to the function in standalone fashion, and a second procedure in accordance with which the electronic apparatus performs a process corresponding to the function in cooperation with an external apparatus; and
displaying one of an operation screen of the electronic apparatus having at least one operation button and an operation screen of the external apparatus having at least one operation button,
wherein the displaying includes displaying the operation button that is associated with information related to the first procedure corresponding to the function if the operation screen of the electronic apparatus is displayed, and displaying the operation button that is associated with information related to the second procedure corresponding to the function if the operation screen of the external apparatus is displayed.
